(19) United States
(12) Patent Application Publication
(10) Pub. No.: US 2012/0008776 A1
(43) Pub. Date: Jan. 12, 2012

(54) WIRELESS COMMUNICATION APPARATUS

(75) Inventors: Chie Ishida, Kanagawa (JP); Takahisa Aoyama, Kanagawa (JP); Takashi Tamura, Kanagawa (JP)

(73) Assignee: PANASONIC CORPORATION, Osaka (JP)

(21) Appl. No.: 13/257,896

(22) PCT Filed: Mar. 16, 2010
(86) PCT No.: PCT/JP2010/001887

§ 371 Date: Sep. 20, 2011

(30) Foreign Application Priority Data
Mar. 30, 2009 (JP) 2009-083224

(51) Int. Cl. H04W 12/04; H04W 36/00

(52) U.S. Cl. 380/247

(57) ABSTRACT

Influence on a key used between a user equipment and a base station, which will be imposed by unsecured updating of a key between the base station and a relay node when a relay node is being introduced is diminished. An HO request processing unit (202) extracts user equipment information from an HO request input from a receiver (201). A user equipment information determination section (204) determines a mode of handover from the user equipment information, and outputs a determination result to a key generator (205) and an HO command generator (207). In relation to a determination about a mode of handover on the basis of user equipment information, it is determined whether the handover is handover from a relay node to a base station, handover from a base station to a relay node, handover relating to relay nodes subordinate to the same base station, and the like. Then, preparation of handover command, updating of a key, and the like are performed in conformance with the mode of handover

### TECHNICAL FIELD

The present invention relates to a field of wireless communication technology and, more particularly, to a wireless communication apparatus applicable to a wireless communication base station apparatus, a wireless communication user equipment, or the like.

### BACKGROUND ART

The 3rd-generation Partnership Project (3GPP) that is an international standardization organization for mobile communication has pursued standardization of LTE (Long Term Evolution) as a next-generation mobile communication system. An LTE-Advanced (Long Term Evolution Advanced) system is a communication system evolved from LTE and aims at providing further enhanced mobile communication service.

In relation to a cellular mobile communication system, techniques for accomplishing a high transmission rate by utilization of a high-frequency wireless band have recently been studied actively in order to realize large-volume data transfer in accordance with a trend toward multimedia information.

However, when a high-frequency wireless band is utilized, accomplishment of a high transmission rate can be expected within a short distance, whilst attenuation attributable to an increase in transmission distance becomes greater as the distance becomes longer. Therefore, when the mobile communication system utilizing the high-frequency wireless band is actually put into practice, a communication area covered by a base station becomes smaller, which in turn raises a necessity to install a larger number of base stations. Since installing base stations involves consumption of commensurate cost, techniques for realizing communication service utilizing a high-frequency wireless band while suppressing an increase in the number of base stations have been strongly desired.

As shown in FIG. 1, in answer to such a demand, introducing into a mobile communication network system a relay node (RN) assuming a role of relaying communication between a base station and a user equipment has been conceived in order to enlarge a communication area covered by each of base stations. FIG. 1 is an illustration showing an example configuration of a cellular mobile communication system including introduced relay nodes. Relay nodes 103A, 103B, and 103C are installed along a cell edge corresponding to a periphery of a communication area 111 covered by a base station 101 with a view toward enhancing receiving efficiency of the base station 101 achieved at the cell edge. The relay nodes 103A, 103B, and 103C belong to at least one base station 101 of neighbor base stations and have a function of relaying communication between the corresponding base station 101 and a user equipment 102.

Since communication between the user equipment and the base station is performed along a wireless path, encryption keys are used in order to carry out secure communication. By reference to FIGS. 14 and 15, generation of keys during establishment of a connection between the user equipment and the base station and exchange of keys during handover are now described. FIG. 14 is a sequence diagram showing procedures for generating keys at the time of establishment of a connection between a user equipment and a base station. FIG. 15 is a sequence diagram showing procedures for exchanging keys during handover.

As shown in FIG. 14, a user equipment (UE: User Agent) 1502 and an MME (Mobility Management Entity) 1505 that is a high-level management node hold a common key K_ASME. Each of the user equipment and the MME multiplies the K_ASME by a NAS (Non Access Stratum) uplink count (NAS UL COUNT), thereby generating a key K_eNB (S501 and S503). Key information NH (Next Hop) is produced from the key K_ASME and the key K_eNB (S502 and S504). Generation of keys is performed at authentication of a user equipment in the cellular mobile communication system and updating of the key K_ASME, such as power-on of the user equipment 1502.

When establishing an RRC (Radio Resource Control) connection with a base station (eNB: evolved Node-B) 1501, the user equipment 1502 transmits and receives an RRC connection request (RRC connection req), an RRC connection setup, and an RRC connection setup complete between the user equipment 1502 and the base station 1501 (S505, S506, and S507), and an NAS message is transferred from the base station 1501 to the MME 1505 (S508). The MME 1505 notifies the base station 1501 of the key K_eNB and the key information NH (S509). The NCC (NH Chaining Counter) performs count-up operation every time the key information NH is updated and shows the number of time key information NH is produced and the number of times the key information NH is updated.

During communication performed after establishment of the RRC connection, the user equipment 1502 and the base station 1501 can perform secure communication by use of a common key K_eNB. When performing secure communication, an SMC (Security Mode Command), an RRC connection reconfiguration, SMC complete, and RRC connection reconfiguration complete are exchanged between the base station 1501 and the user equipment 1502 (S510, S511, S512, and S513). In a subsequent session, communication is performed by means of data encrypted by use of the encryption keys. At this time, the user equipment 1502, the base station 1501, and the MME 1505 hold a common key K_eNB and the key information NH (NCC=1).

As shown in FIG. 15, the user equipment is assumed to perform handover from one base station that is now in communication with the user equipment to another different base station. The user equipment (UE) 1502 holds a connection with a base station (i.e., with a source base station: SeNB) 1501A in a currently communicable serving cell and is using the key K_eNB for communication encryption.

The user equipment 1502 sends a measurement report (MR) including receiving quality of a pilot signal from a base station (i.e., from a target base station: TeNB) 1501B that is to act as a handover destination for the source base station 1501A of the serving cell (S521). The user equipment 1502 measures receiving quality of the target base station 1501B and acquires a physical cell ID (PCI).

After determined a received measurement report and also determined the handover destination as a target base station, the source base station 1501A transmits an HO (Handover) request (HO req) indicating a handover request to the target base station 1501B. At this time, the source base station 1501A produces a key K_eNB* from the key K_eNB used in communication with the user equipment 1502 and the physical cell ID of the target base station 1501B (S522). The key K_eNB* is transmitted to the target base station 1501B while included in the HO request in conjunction with the key information NH (S523).

Upon receipt of the HO request from the source base station 1501A, the target base station 1501B acquires the key K_eNB* and the key information NH included in the HO request and transmits the HO command representing handover to the user equipment 1502 by way of the source base station 1501A (S524 and S525).

Upon receipt of the HO command transmitted from the target base station 1501B by way of the source base station 1501A, the user equipment 1502 produces a new key K_eNB* from the key K_eNB used in communication with the source base station 1051A and the previously acquired physical cell ID of the target base station 1501B (S526).

Subsequently, the user equipment 1502 transmits to the target base station 1501B an RACH (Random Access Channel) message (Synchronization) for assuring synchronization (S527), and an uplink resource (UL allocation) is given by the target base station 1501B (S528). The RRC connection reconfiguration complete (RRC connection reconfig comp) is transmitted from the user equipment 1502 to the target base station 1501B (S529), and a path switching request (Path Switching request) is transmitted from the target base station 1501B to the MME 1505 (S530). The MME 1505 updates the key information to new key information NH* (NCC=2) from the key K_ASME and the key information NH (S531). The key information NH* is transmitted to the target base station 1501B while included in an ACK response (ack) (S532). Handover is performed from one base station to another base station through a round of above-mentioned processing operations.

In a session subsequent to handover, the new key K_eNB* is used for encrypting communication between the user equipment 1502 and the target base station 1501B, and the old key K_eNB is deleted.

### CITATION LIST

### Patent Literature

Patent Literature 1: WO2006/003859A1

### Non-Patent Literature

Non-Patent Literature 1: 3GPP TS 33.401 v8.2.1 “3GPP System Architecture Evolution (SAE): Security Architecture: (Release 8)”

### SUMMARY OF THE INVENTION

### Technical Problem

A cellular mobile communication system is assumed to perform secure communication that uses encryption keys, such as those mentioned above, by means of introducing relay nodes in order to enlarge areas covered by respective base stations. When the relay nodes are introduced, the base stations and the relay nodes are connected together by means of wireless communication. Therefore, as a result of a key identical with the key used between a user equipment and the base station being also used between a user equipment and the relay nodes, the number of times the key is exchanged over the wireless channel is increased, which raises a problem of a reduction in degree of reliability.

Further, an old key of the source of generation is deleted after generation of the new key. However, in the case of handover from the base station to the relay node, if the old key K_eNB is deleted after generation of a new key K_RN between the user equipment and the relay node, data are encrypted by use of the key K_RN used between the user equipment and the relay node. In accordance with updating of the key K_RN, the key used in communication between the base station and the relay node is also updated frequently.

The present invention has been conceived under the circumstances. A first objective of the invention is to diminish influence on a key used between a user equipment and a base station, which will be imposed by unsecured updating of a key between the base station and a relay node when a relay node is being introduced into a cellular mobile communication system.

A second objective of the present invention is to enable correct generation and use of a common key between a user equipment and a base station and communication between the user equipment and a relay node when a relay node is being introduced into a cellular mobile communication system.

### Solution to Problem

In a first aspect of the present invention, there is provided a wireless communication apparatus, including: a receiver that receives a handover request representing a request for handover, which is sent from another apparatus, and receives key information about an encryption key; a handover request processing unit that processes the handover request received by the receiver; a key information storage section that stores the key information received by the receiver; a user equipment information determination section that determines a mode of handover in accordance with user equipment information extracted by the handover request processing unit; a key generator that generates a key from the key information stored in the key information storage section in accordance with a determination result of the user equipment information determination section; a handover command preparation section that prepares a handover command for commanding performance of handover in accordance with the determination result of the user equipment information determination section; and, a transmitter that transmits the handover command prepared by the handover command preparation section.

By means of the configuration, it becomes possible to perform preparation of the handover command, generation of the key, updating of the key, and other operations, in conformance with the mode of handover and in accordance with the determination result based on user equipment information. It thereby becomes possible to diminish influence on a key used between a user equipment and a base station, which will be imposed by unsecured exchange of a key between the base station and a relay node when a relay node is being introduced into a cellular mobile communication system.

A second aspect of the present invention is directed toward the wireless communication apparatus in which, when a user equipment that is in communication with the apparatus which has transmitted the handover request performs handover from a base station to a relay node subordinate to the base station, the user equipment information determination section commands the handover command preparation section to prepare a handover command including a command for holding a key that is a source of generation of the key.

By means of the configuration, when handover from the base station to a relay node subordinate to the base station is performed, a command is issued so as to hold the key that is the source of generation of the key, whereby the number of times the key used between the base station and the relay node is updated can be reduced. Therefore, it becomes possible to diminish influence on a key used between a user equipment and a base station, which will be imposed by unsecured exchange of a key between the base station and the relay node.

A third aspect of the present invention is directed toward the wireless communication apparatus in which, either when a user equipment that is in communication with the apparatus which has transmitted the handover request performs handover from a relay node to a high-level base station to which the relay node is subordinate or when the user equipment performs handover from a relay node to another base station to which the relay node is not subordinate, the user equipment information determination section commands the handover command preparation section to prepare a handover command including a command for updating a key used between the high-level base station for the relay node and the user equipment.

By means of the configuration, either when there is performed handover from the relay node to a high-level base station to which the relay node is subordinate or when there is performed handover from the relay node to another base station to which the relay node is not subordinate, a command for updating the key used between the high-level base station for the relay node and the user equipment is issued, whereby secure communication between the user equipment and the base station can be performed by use of the updated new key.

A fourth aspect of the present invention is directed toward the wireless communication apparatus in which, either when the user equipment that is in communication with the apparatus which has transmitted the handover request performs handover from one relay node to another relay node that are subordinate to the same base station, when the user equipment performs handover from one base station to a relay node subordinate to a different base station, or when the user equipment performs handover from a relay node subordinate to one base station to a relay node subordinate to another base station, the user equipment information determination section commands the handover command preparation section to prepare a handover command including a physical cell ID of the corresponding base station.

By means of the configuration, either when there is performed handover from one relay node to another relay node that are subordinate to the same base station, when there is performed handover from one base station to a relay node subordinate to a different base station, or when there is performed handover from a relay node subordinate to one base station to a relay node subordinate to another base station, the physical cell ID of the base station is notified while being included in the handover command, whereby it becomes possible to generate a new key using the physical cell ID. It thereby becomes possible to perform secure communication between the user equipment and the relay node by use of a newly generated key.

A fifth aspect of the present invention is directed toward the wireless communication apparatus that further includes: a connection setup complete message acquisition section that acquires a connection setup complete message which indicates completion of setup of a connection between a user equipment and a base station or between the user equipment and a relay node; and a security mode command preparation section that prepares a security mode command that is a command pertaining to communication encryption, wherein the user equipment information determination section determines whether the connection setup complete message extracted by the connection setup complete message acquisition section has been sent by way of the relay node.

By means of the configuration, it becomes possible to prepare a security mode command according to a mode of handover, by means of determining whether or not the thus-transferred connection setup complete message has been sent by way of the relay node. The security mode command makes it possible to correctly generate and use a common key between the user equipment and the base station and the user equipment and the relay node.

A sixth aspect of the present invention is directed toward the wireless communication apparatus in which, when the connection setup complete message has been sent by way of the relay node in accordance with a determination result of the user equipment information determination section, the security mode command preparation section prepares a security mode command including a command for preparation of a key used between the relay node and the user equipment as well as preparation of a key used between the base station and the user equipment.

By means of the configuration, when the connection setup complete message has been sent by way of the relay node, a command for generation of a key used between the relay node and the user equipment as well as a key used between the base station and the user equipment is issued. As a result, it becomes possible to correctly generate and use a common key between the user equipment and the base station and between the user equipment and the relay node.

In a seventh aspect of the present invention, there is provided a wireless communication apparatus including: a receiver that receives a handover command for commanding performance of handover sent from another apparatus and receives a pilot signal included in a transmission signal; a handover command processing unit that processes the handover command which has been received by the receiver and which is commensurate with a mode of handover; a key generator that generates a key in accordance with the handover command; a key information storage section that stores the key generated by the key generator; a receiving quality measurement section that measures receiving quality of the pilot signal received by the receiver; a measurement report preparation section that prepares a measurement report from a measurement result of the receiving quality measurement section; and a transmitter that transmits the measurement report.

By means of the configuration, it becomes possible to measure received quality of the pilot signal, to prepare a measurement report, to transmit the report to a base station or a relay node, and to generate or update a key according to the handover command and in conformance with the mode of handover. It thereby becomes possible to diminish influence on a key used between a user equipment and a base station, which will be imposed by unsecured exchange of a key between the base station and a relay node when a relay node is introduced into a cellular mobile communication system.

An eighth aspect of the present invention is directed toward the wireless communication apparatus in which, when the handover command includes a command for holding a key that is a source of generation of the key, the handover command processing unit commands the key generator to store both a new key and the key that is the source of generation of the key after generation of the new key.

By means of the configuration, when the handover command includes a command for holding a key that is a source of generation of the key, a new key and the key that is the source of generation of the key are stored after generation of the new key. Thereby, it is possible to reduce the number of times a key used between the base station and the relay node is updated. Therefore, it becomes possible to diminish influence on a key used between a user equipment and a base station, which will be imposed by unsecured exchange of a key between the base station and the relay node.

A ninth aspect of the present invention is directed toward the wireless communication apparatus in which, when the handover command includes a command for updating a key used between a base station and a user equipment, the handover command processing unit commands the key generator to fetch the key used between the base station and the user equipment from the key information storage section, to generate a new key, and to input the thus-generated new key into the key information storage section.

By means of the configuration, when the handover command includes a command for updating the key used between the base station and the user equipment, a new key is generated, thereby making it possible to perform secure communication between the user equipment and the base station by use of an updated new key.

A tenth aspect of the present invention is directed toward the wireless communication apparatus in which, when the handover command includes a physical cell ID of the base station, the handover command processing unit commands the key generator to fetch the key used between the base station and the user equipment from the key information storage section, generate a new key, to generate another key to be used between the relay node and the user equipment from the thus-generated new key, and input the newly generated two keys into the key information storage section.

By means of the configuration, when the handover command includes a physical cell ID of the base station, the key generator generates a new key by use of the physical cell ID and further generates from the new key another key to be used between the relay node and the user equipment, thereby making it possible to perform secure communication between the user equipment and the relay node by use of the thus-generated new key.

An eleventh aspect of the present invention is directed toward the wireless communication apparatus further including a security mode command processing unit that processes a security mode command that has been received by the receiver and that is a command pertaining to communication encryption, wherein, when the security mode command includes a command for generating a key to be used between the relay node and the user equipment as well as including a key to be used between the base station and the user equipment, the security mode command processing unit commands the key generator to fetch the key used between the base station and the user equipment from the key information storage section and newly generate a key to be used between the relay node and the user equipment.

By means of the configuration, when the security mode command includes a command for generating a key to be used between the relay node and the user equipment as well as a key to be used between the base station and the user equipment, the key generator newly generates a key to be used between the relay node and the user equipment, thereby making it possible to correctly generate and use a common key to be used between the user equipment and the base station and between the user equipment and the relay node.

A twelfth aspect of the present invention provides a base station apparatus including any one of the pieces of the previously-described wireless communication apparatus.

A thirteenth aspect of the present invention provides a user equipment including any one of the pieces of the previously-described wireless communication apparatus.

A fourteenth aspect of the present invention provides a wireless communication system including the base station apparatus described in connection with the twelfth aspect and the user equipment described in connection with the thirteenth aspect.

### Advantageous Effects of the Invention

The present invention makes it possible to diminish influence on a key used between a user equipment and a base station, which will be imposed by unsecured updating of a key between the base station and a relay node when a relay node is being introduced into a cellular mobile communication system.

Further, the present invention also enables correct generation and use of a common key between a user equipment and a base station and between the user equipment and a relay node when a relay node is being introduced into a cellular mobile communication system.

### BRIEF DESCRIPTION OF THE DRAWINGS

FIG. 1 is an illustration showing an example configuration of a cellular mobile communication system into which relay nodes are introduced.

FIG. 2 is a block diagram showing the configuration of a base station according to a first embodiment of the present invention.

FIG. 3 is a block diagram showing a configuration of a user equipment according to the first embodiment of the present invention.

FIG. 4 is a flowchart showing operation of the base station according to the first embodiment of the present invention.

FIG. 5 is a flowchart showing operation of the user equipment according to the first embodiment of the present invention.

FIG. 6 is a signaling diagram showing first example signaling between the base station and the user equipment according to the first embodiment of the present invention.

FIG. 7 is a signaling diagram showing second example signaling between the base station and the user equipment according to the first embodiment of the present invention.

FIG. 8 is a signaling diagram showing third example signaling between the base station and the user equipment according to the first embodiment of the present invention.

FIG. 9 is a block diagram showing a configuration of a base station according to a second embodiment of the present invention.

FIG. 10 is a block diagram showing a configuration of a user equipment according to the second embodiment of the present invention.

FIG. 11 is a flowchart showing operation of the base station according to the second embodiment of the present invention.

FIG. 12 is a flowchart showing operation of the user equipment according to the second embodiment of the present invention.

FIG. 13 is a signaling diagram showing first example signaling between the base station and the user equipment according to the second embodiment of the present invention.

FIG. 14 is a sequence diagram showing procedures for generating a key at the time of establishment of a connection between a user equipment and a base station.

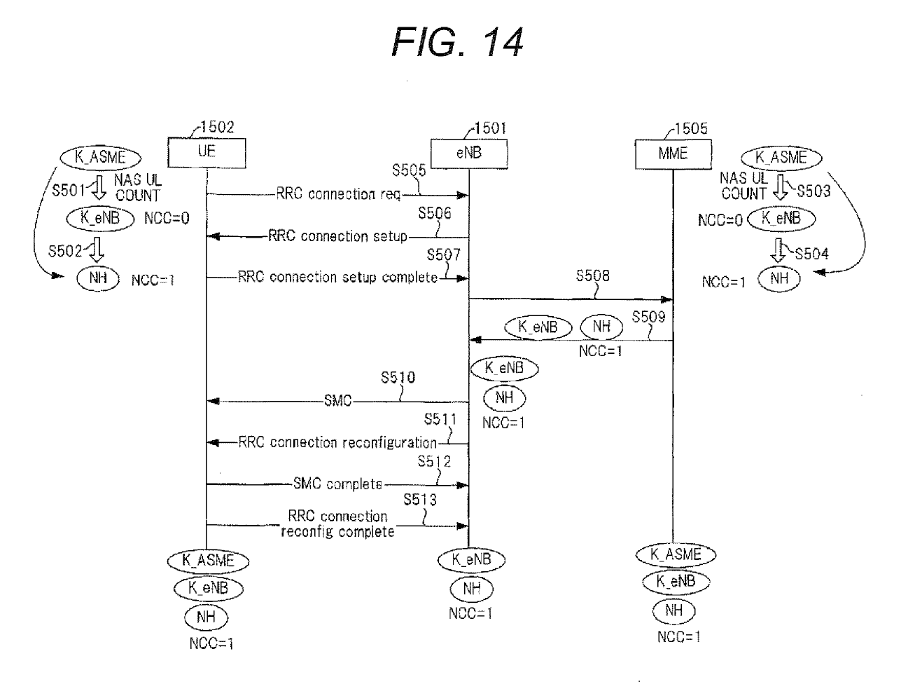

FIG. 15 is a sequence diagram showing procedures for exchanging a key during handover.

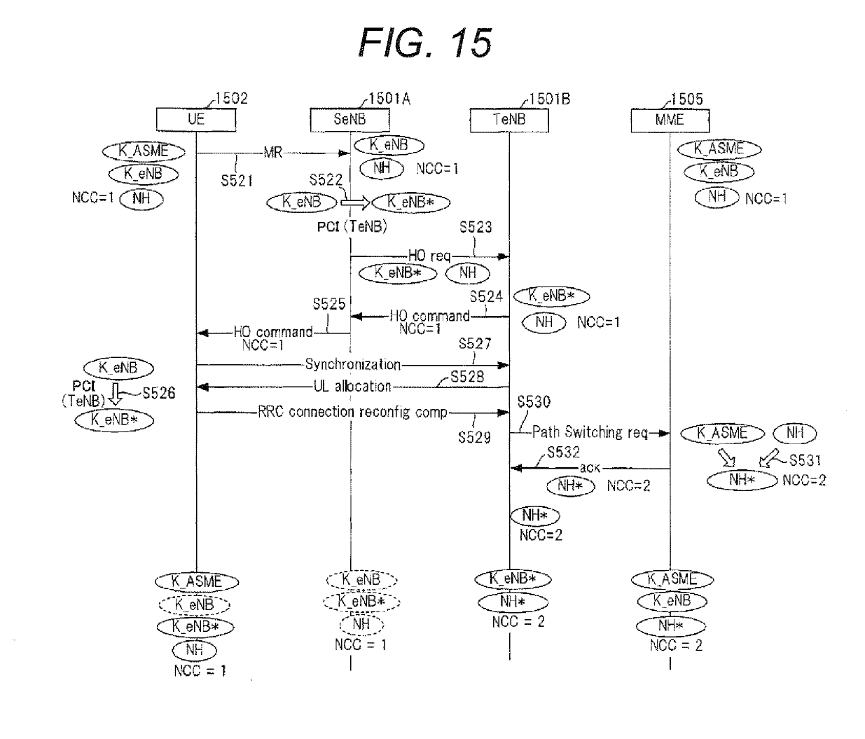

### DESCRIPTION OF THE EMBODIMENTS

Embodiments of the present invention will be hereunder described in detail by reference to the drawings. In the embodiments, configurations having the same functions are assigned the same reference signs/numerals, and their repeated explanations are omitted.

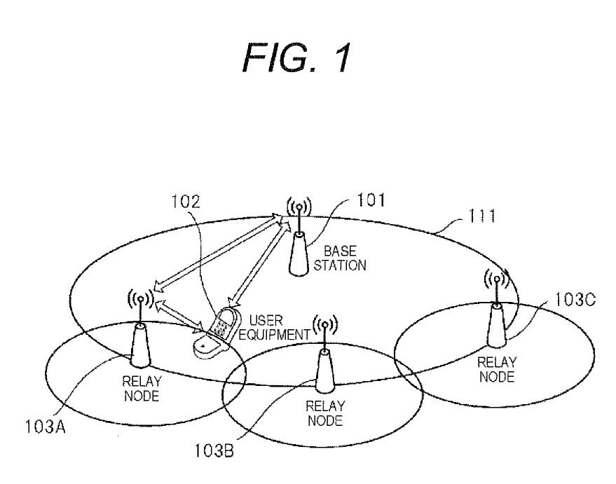

The embodiments show examples in which a wireless communication apparatus according to an aspect of the present invention is applied to a cellular mobile communication system for mobile communication, such as a portable phone. As shown in FIG. 1, the cellular mobile communication system of the embodiments is configured such that relay nodes 103A, 103B, and 103C are installed along a cell edge of a base station 101, to thus enable the relay nodes 103A, 10313, and 103C to relay communication between the base station 101 and a user equipment 102. LTE, LTE-Advanced, or the like, is applicable to the communication system.

### First Embodiment

A first embodiment provides a proposal for determining a command for updating an encryption key sent to a user equipment or a high-level management node according to release information about the user equipment and a mode of handover when the base station has received an HO request representing a handover request from another device. It thereby becomes possible to lessen influence on a key used between the user equipment and the base station, which will be imposed by unsecured exchange of a key between the base station and the relay node when the relay nodes are being introduced. Further, it is possible to correctly generate and use a common key between the user equipment and the base station and between the user equipment and the relay node.

In the first embodiment, the user equipment is assumed to designate a user equipment compatible with LTE-Advanced (or LTE-Advanced user equipment) unless otherwise specified.

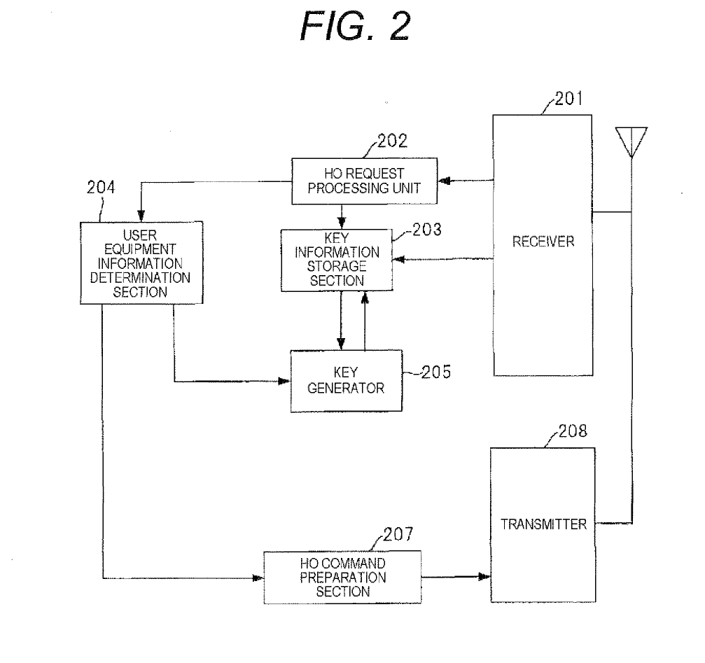

The configuration of the base station according to the first embodiment of the present invention is described by reference to a block diagram shown in FIG. 2.

A receiver 201 has a reception RF section, a baseband signal processing unit, and the like, and performs processing for demodulation, decoding, and the like, of a signal received by an antenna. The receiver 201 receives an HO request, which represent a handover request from another base station, and information about an encryption key from a high-level management node, or the like. The receiver 201 outputs the thus-received HO request to an HO request processing unit 202 and the thus-received information to a key information storage section 203.

The HO request processing unit 202 extracts user equipment information from the HO request input from the receiver 201 and outputs the thus-extracted user equipment information to a user equipment information determination section 204. The HO request processing unit 202 extracts key information included in the HO request and outputs the thus-extracted key information to the key information storage section 203.

The user equipment information determination section 204 determines a mode of handover from the user equipment information input by the HO request processing unit 202 and outputs a determination result to the key generator 205 and an HO command generator 207. Determination about a mode of handover on the basis of user equipment information includes handover from a relay node to a base station, handover from a base station to a relay node, handover from one base station to another base station, and the like. In the case of handover relating to relay nodes, a determination of handover includes handover between relay nodes subordinate to the same base station, handover to a different base station to which the relay node is not subordinate, handover to a relay node subordinate to the different base station, and the like.

The key generator 205 acquires required key information from the key information storage section 203 according to a determination result input by the user equipment information determination section 204, generates an encoding key, and outputs the thus-generated key to the key information storage section 203.

The key information storage section 203 stores key information input by the receiver 201, the HO request processing unit 202, and the key generator 205. Further, required key information is output to the key generator 205.

The HO command preparation section 207 prepares an HO command that is a response command for commanding performance of handover in response to the HO request from another base station according to the determination result input by the user equipment information determination section 204; and outputs the thus-generated HO command to a transmitter 208.

The transmitter 208 has a baseband signal processing unit, a transmission RF section, and the like, and performs encoding, modulation, and like processing, of a transmission signal. The transmitter 208 transmits the HO command input by the HO command preparation section 207 through an antenna.

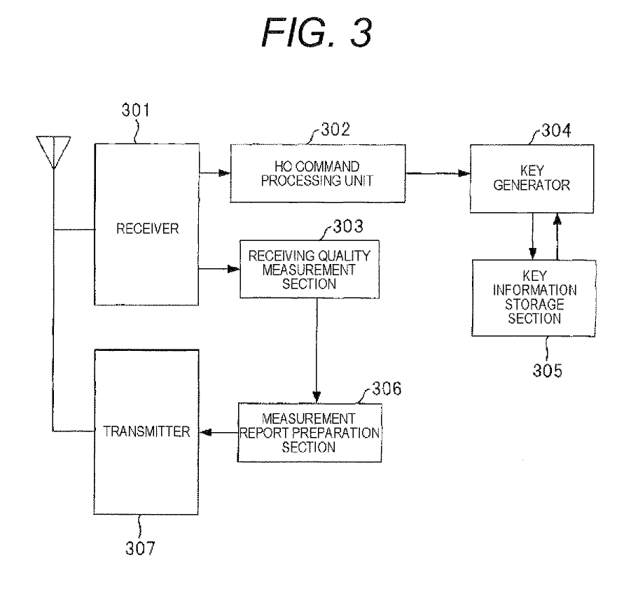

The configuration of the user equipment according to the first embodiment of the present invention is described by reference to a block diagram shown in FIG. 3.

A receiver 301 has a reception RF section, a baseband signal processing unit, and the like, and performs processing of demodulation, decoding, and like processing, of a signal received by an antenna. The receiver 301 receives an HO command and a pilot signal included in a transmission signal, both of which are sent from another base station. The HO command is output to an HO command processing unit 302, and the pilot signal is transmitted to a receiving quality measurement section 303.

The HO command processing unit 301 commands a key generator 304 to generate a key in accordance with the HO command input by the receiver 301.

The key generator 304 acquires required information from a key information storage section 305 in accordance with the command input by the HO command processing unit 302; generates an encryption key; and outputs the thus-generated encryption key to the key information storage section 305.

The key information storage section 305 stores key information input by the key generator 304. The key information storage section 305 further outputs necessary key information to the key generator 304.

The receiving quality measurement section 303 measures receiving quality of the pilot signal input by the receiver 301 and outputs a measurement result to a measurement report preparation section 306. RSRP (Reference Signal Receiving Power), RSRQ (Reference Signal Receiving Quality), or the like, is used as the receiving quality.

The measurement report preparation section 306 prepares a measurement report (MR) from the measurement result input by the receiving quality measurement section 303 and outputs the thus-prepared measurement report to a transmitter 307.

The transmitter 306 includes a baseband signal processing unit, a transmission RF section, and the like, and performs processing of encoding, modulation, and like processing, of a transmission signal. The transmitter 307 transmits the measurement report input by the measurement report preparation section 306 through the antenna.

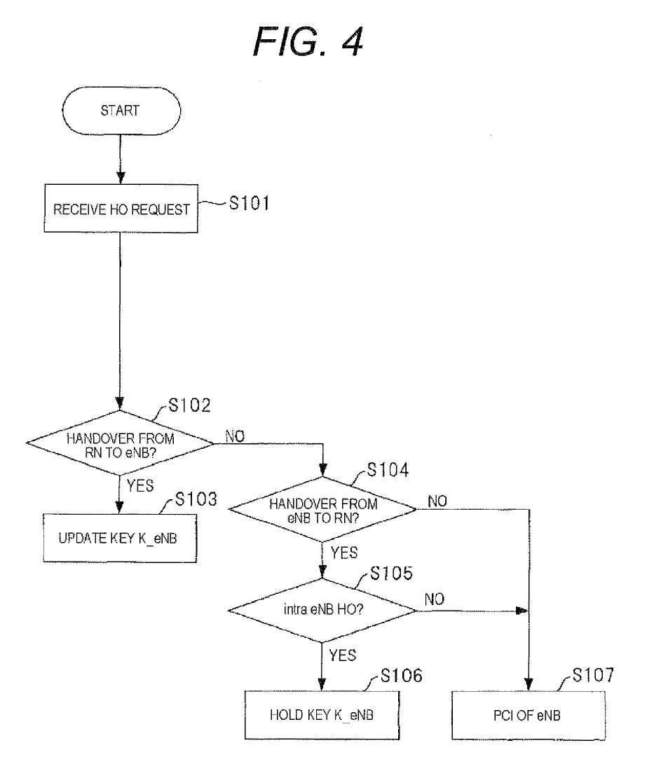

Operation of the base station according to the first embodiment of the present invention is now described by reference to the flowchart shown in FIG. 4.

The base station 101 receives an HO request from a subordinate relay node or another base station by way of the receiver 201 and the HO request processing unit 202 (S101).

Next, the user equipment information determination section 204 determines whether or not the HO request is concerned with handover from the relay node to the base station (RN→eNB) (S102). When the HO request is concerned with handover from the relay node to the base station, the base station prepares an HO command, which includes a command for the user equipment and intended for updating the encryption key K_eNB, by means of the HO command preparation section 207 (S103). The transmitter 208 transmits the HO command to the relay node or the base station that is the source of transmission of the HO request.

When the HO request is not concerned with handover from the relay node to the base station, the user equipment information determination section 204 determines whether or not the HO request is concerned with handover from the base station to the relay node (eNB→RN) (S104). When the HO request is concerned with handover from the base station to the relay node, the user equipment information determination section 204 determines whether or not handover is performed within a communication area covered by the same base station (intra eNB HO) (S105). When the HO request is concerned with handover performed within a communication area covered by the same base station, the base station prepares an HO command for the user equipment, which includes a command for retaining the key K_eNB, by means of the HO command preparation section 207 (S106). The transmitter 208 transmits the HO command to the user equipment.

When the HO request is not concerned with handover performed within a communication area covered by the same base station and when the HO request is not concerned with handover from the base station to a relay node; namely, when the HO request is concerned with handover from one relay node to another relay node, the base station prepares for the user equipment the HO command, which includes its own physical cell ID (PCI), by means of the HO command preparation section 207 (S107). The transmitter 208 transmits the HO command to the relay node or the base station that is the source of transmission of the HO request.

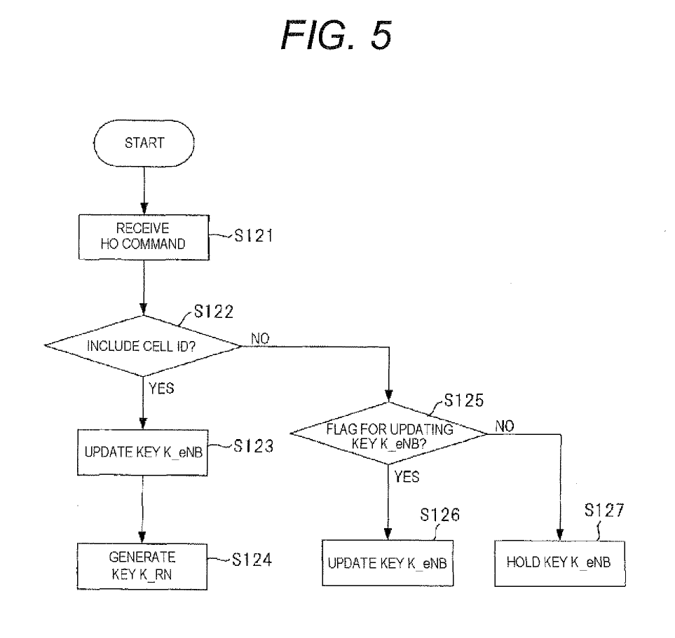

Operation of the user equipment according to the first embodiment of the present invention is now described by reference to the flowchart shown in FIG. 5.

The user equipment 102 receives an HO command from a base station or a relay node in a currently communicable serving cell, by means of the receiver 301 and the HO command processing unit 302 (S121).

The HO command processing unit 302 then determines whether or not the physical cell ID is included in the HO command (S122). When the HO command includes the physical cell ID, the key generator 304 updates the key K_eNB by use of the physical cell ID (S123) and further generates the key K_RN from a new key K_eNB (i.e., K_eNB*) (S124).

When the HO command does not include the physical cell ID, the HO command processing unit 302 determines whether or not a K_eNB flag is included, as a command for updating the key K_eNB, in the HO command (S125). When the HO command includes the command for updating the key K_eNB, the user equipment updates the key K_eNB by means of the key generator 304 (S126). When the HO command does not include the command for updating the key K_eNB, the user equipment generates the key K_RN from the key K_eNB by means of the key generator 304. Even after completion of handover, the key K_eNB that is the source of generation of the key is retained (S127).

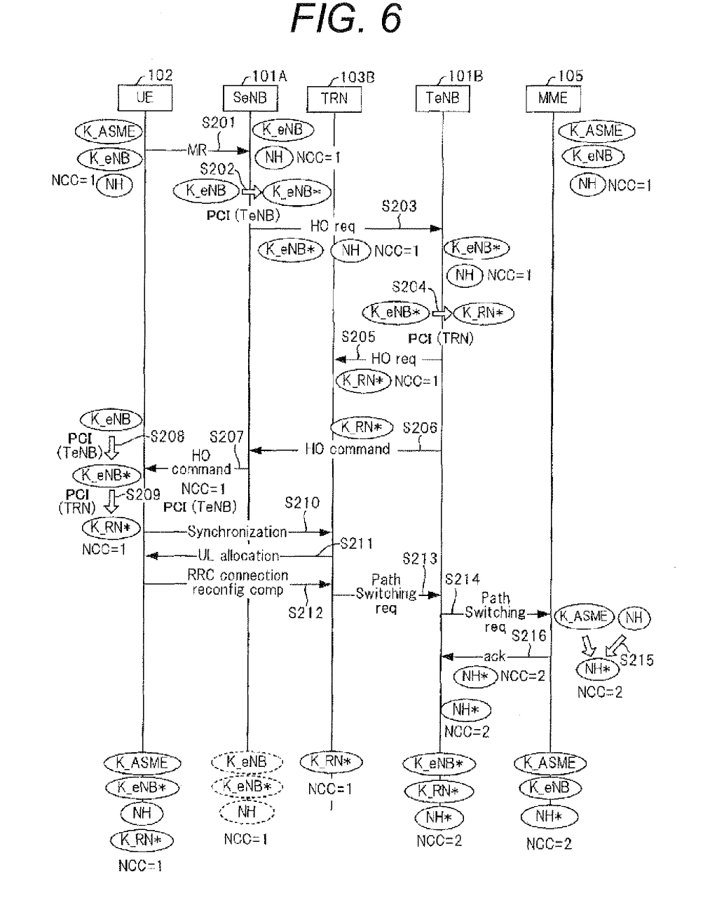

Example signaling performed between the base station and the user equipment in the first embodiment of the present invention is now described by reference to signaling charts shown in FIGS. 6 through 8.

The first embodiment shown in FIG. 6 corresponds to processing performed by the base station to bring the physical cell ID in the HO command along the flowchart in the base station shown in FIG. 4 (S107) and also operation performed by the user equipment to update the key K_eNB and generate the key K_RN (S123 and S124) along the flowchart in the user equipment shown in FIG. 5.

In FIG. 6, the user equipment is assumed to perform handover from the base station that is now in communication to a relay node subordinate to a different base station. The user equipment (UE) 102 now holds a connection with the base station (the source base station: SeNB) 101A in the currently communicable serving cell and is using the key K_eNB for communication encryption.

The user equipment 102 sends a measurement report (MR), which includes receiving quality of the pilot signal from the relay node that is to serve as a handover destination (the target relay node: TRN) 103B, to the base station (the source base station) 101A for the serving cell (S201). The user equipment 102 at this time acquires the physical cell ID (PCI) as well as measuring receiving quality of the target relay node 103B.

The source base station 101A determines the received measurement report, and when determined the handover destination as the target relay node, the source base station 101A subsequently transmits the HO request (HO req) to a base station (a target base station: TeNB) 101B serving as a master of the target relay node. The source base station 101A at this time multiplies the key K_eNB used in communication with the user equipment 102 by the physical cell ID of the target base station 101B, thereby generating the key K_eNB* (S202), and transmits the key K_eNB* to the target base station 101E along with the key information NH (NCC=1) while included in the HO request (S203).

Upon receipt of the HO request from the source base station 101A, the target base station 101B determines that the HO request is concerned with handover from a different base station to a relay node subordinate to the own. In this case, the target base station 101B prepares an HO command including its own physical cell ID and transmits the thus-prepared command to the user equipment 102 by way of the source base station 101A (S5206 and S207).

Concurrently, the target base station 101B multiplies the key K_eNB* received by means of the HO request by the physical cell ID of the target relay node, thereby generating a key K_RN* (S204). The HO request including the key K_RN* is transmitted to the target relay node 103B that is to serve as a handover destination (S205).

Upon receipt of the HO command transmitted from the target base station 101B by way of the source base station 101A, the user equipment 102 determines that the HO command includes the physical cell ID. In this case, the user equipment 102 multiplies the key K_eNB used in communication with the source base station 101A by the physical cell ID transmitted by means of the HO command, thereby generating a new key K_eNB* (S208). Further, the thus-generated key K_eNB* is multiplied by the physical cell ID of the target relay node 103B, thereby generating a key K_RN* (S209).

Subsequently, the user equipment 102 transmits an RACH message (Synchronization) to the target relay node 103B to achieve synchronization (S210) and is allocated an uplink resource (UL allocation) by the target relay node 103B (S211). An RRC connection reconfiguration complete is transmitted from the user equipment 102 to the target relay node 103B (S212), and a path switching request (Path Switching req) is transmitted from the target relay node 103B to the MME 105 that is a high-level management node by way of the target base station 10113 (S213 and S214). The MME 105 updates the key information to new key information NH* (NCC=2) from the key K_ASME and the key information NH (S215) and transmits the key information NH* to the target base station 101B while holding the key information NH* included in the ACK response (ack) (S216). Handover from one base station to a relay node subordinate to another base station is performed through a round of the previously described processing operations.

Subsequent to performance of handover, the key K_RN* is used for encrypting communication (RRC signaling) between the user equipment 102 and the target relay node 103B and also uses the key K_eNB* for encrypting communication (data signaling) between the user equipment 102 and the target base station 101B.

Moreover, the user equipment 102 and the source base station 101A delete the key K_eNB used for encrypting communication between the user equipment 102 and the source base station 101A.

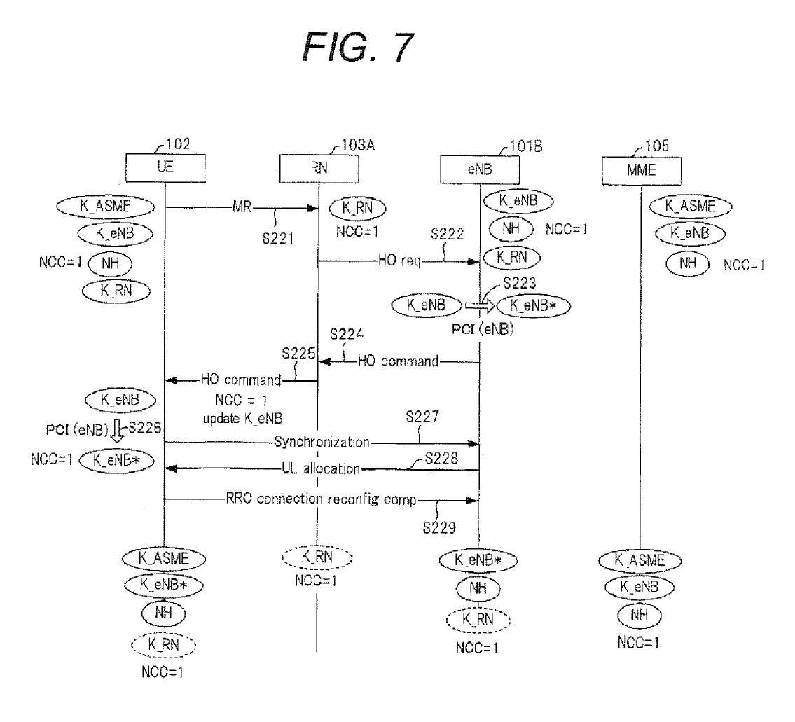

A second example shown in FIG. 7 corresponds to operation by means of which the base station brings a command for updating the key K_eNB into the HO command along the flowchart in the base station shown in FIG. 4 (S103) and operation by means of which the user equipment updates the key K_eNB (S126) along the flowchart in the user equipment shown in FIG. 5 (S126).

In FIG. 7, the user equipment is assumed to perform handover from the relay node that is now in communication to a base station that is the master of the relay node. The user equipment (UE) 102 holds a connection with the relay node (RN) 103A in a currently communicable serving cell and uses the key K_RN for encrypting RRC signaling and the key K_eNB for encrypting data signaling.

The user equipment 102 transmits a measurement report (MR), which includes receiving quality of the pilot signal from the target base station (eNB) 101B that is to serve as a handover destination, to the relay node (source relay node) 103A of the serving cell (S221). The user equipment 102 at this time measures receiving quality of the target base station 101E and acquires the physical cell ID (PCI).

The source relay node 103A determines the received measurement report, and when determined a master base station (a target base station) of the relay node as a handover destination, and the source relay node 103A transmits an HO request (HO req) to the target base station 101B (S222).

Upon receipt of the HO request from the source relay node 103A, the target base station 101B determines that the HO request is concerned with handover from the relay node subordinate to the own. In this case, the target base station 101B prepares an HO command including a command for updating the key K_eNB and transmits the thus-prepared command to the user equipment 102 by way of the source relay node 103A (S224, S225). Concurrently, the target base station 101B multiplies the key K_eNB used for encrypting data signaling between the user equipment 102 and the base station by the its own physical cell ID, thereby generating a new key K_eNB* (S223).

Upon receipt of the HO command transmitted from the target base station 101B by way of the source relay node 103A, the user equipment 102 determines that the HO command includes a command for updating the key K_eNB. In this case, the user equipment 102 multiplies the key K_eNB used for data signaling between the user equipment and the target base station 101B by the physical cell ID of the target base station 101B, thereby generating a new key K_eNB* (S226).

Subsequently, the user equipment 102 transmits an RACH message (Synchronization) for accomplishing synchronization to the target base station 101B (S227) and is allocated the uplink resource (UL allocation) by the target base station 101B (S228). The user equipment 102 transmits an RRC connection reconfiguration complete (RRC connection reconfiguration comp) to the target base station 101B (S229). Handover from one relay node to its master base station is thus performed through a round of the processing operations.

During operation subsequent to performance of handover, the key K_eNB* is used for encrypting communication between the user equipment 102 and the target base station 101B.

The user equipment 102 and the base station 101B delete the key K_RN used for encrypting communication between the user equipment 102 and the source relay node 103A.

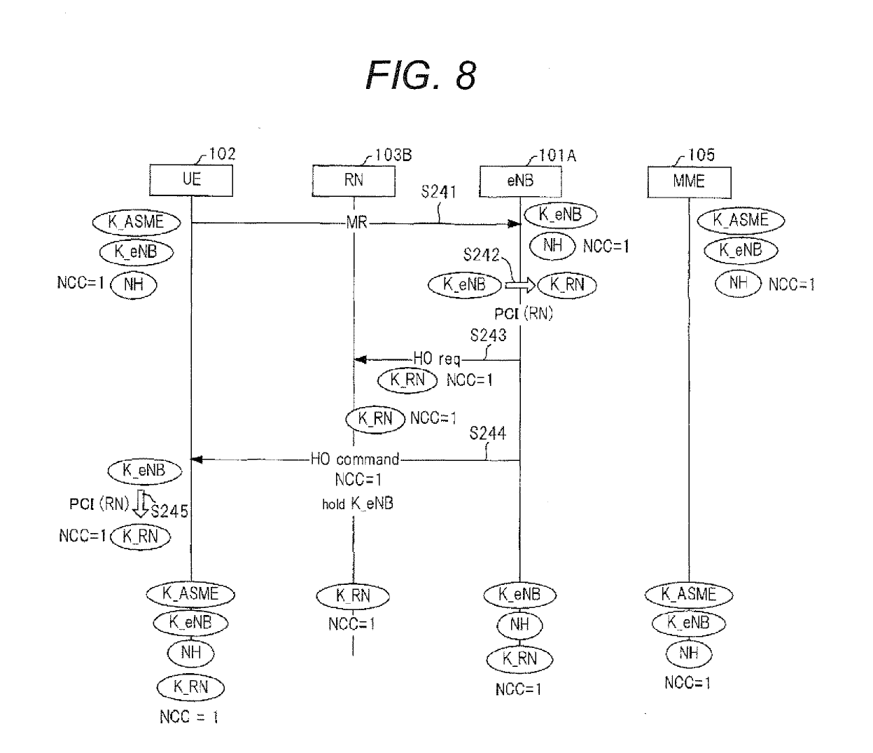

A third example shown in FIG. 8 corresponds to processing through which the base station brings a command for holding the key K_eNB into the HO command along flowchart in the base station shown in FIG. 4 (S106) and processing through which the user equipment holds the key K_eNB along flowchart in the user equipment shown in FIG. 5 (S127).

In FIG. 8, the user equipment is assumed to perform handover from one base station that is in communication to a relay node subordinate to the base station. The user equipment 102 holds a connection with the base station (eNB) 101A in the currently communicable serving cell and is using the key K_eNB for encrypting communication.

The user equipment 102 transmits a measurement report (MR), which includes receiving quality of a pilot signal from the target relay node 103B that is to act as a handover destination, to the base station (the source base station) 101A for the serving cell (S241). The user equipment 102 at this time measures receiving quality of the target relay node 103B and acquires the physical cell ID (PCI).

The source base station 101A determines the thus-received measurement report, and when determined the target relay node subordinate to the own as a handover destination, the source base station 101A transmits an HO request (HO req) to the target relay node 103B. The source base station 101A multiplies the key K_eNB used in communication with the user equipment 102 by the physical cell ID of the target relay node 103B, thereby generating the key K_RN (S242), and transmits the key K_RN while holding the key in the HO request to the target relay node 103B (S243).

The source base station 101A prepares the HO command including a command for holding the key K_eNB and transmits the HO command to the user equipment 102 (S244).

Upon receipt of HO command transmitted from the source base station 101A, the user equipment 102 determines that the HO command includes a command for holding the key K_eNB. In this case, the user equipment 102 multiplies the key K_eNB used in communication with the source base station 101A by the physical cell ID of the target relay node, thereby generating the key K_RN (S245). Even after completion of handover, the key K_eNB is not deleted and retained.

Subsequently, the user equipment 102 transmits to the target relay node 103B the RACH message for accomplishing synchronization and is allocated an uplink resource by the target relay node 103B. Handover from one base station to a relay node subordinate to the base station is performed through a round of the processing operations.

During subsequent to performance of handover, the key K_RN is used for encrypting communication between the user equipment 102 and the target relay node 103B and the key K_eNB is used for encrypting communication between the user equipment 102 and the source base station 101A.

As mentioned above, the first embodiment makes it possible to diminish influence on a key used between the user equipment and the base station, which will be imposed by unsecured updating of a key between the base station and the relay node when the relay nodes are being introduced. Further, it is possible to correctly generate and use a common key between the user equipment and the base station and between the user equipment and the relay node.

### Second Embodiment

A second embodiment provides a proposal for preparing an RRC key used between a user equipment and a relay node and a data key used between the user equipment and a base station at the time of an RRC connection setup. The frequently exchanged data key is thereby taken as a key used between the user equipment and the base station, so that updating of the key used between the base station and the relay node can be reduced. Further, the RRC key is taken as a key used between the user equipment and the relay node, whereby a delay in RRC processing can be shortened.

In the second embodiment, the user equipment is assumed to designate the LTE-Advanced user equipment unless otherwise specified.

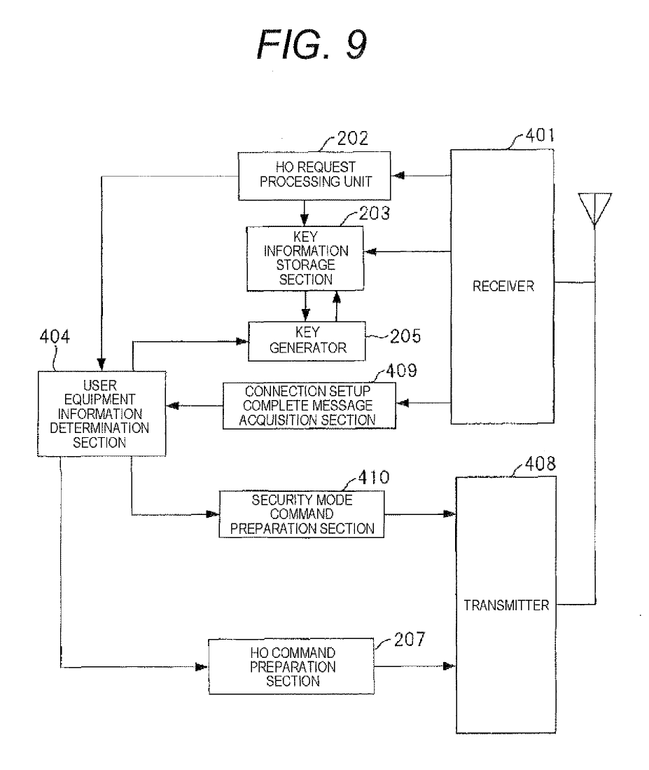

A configuration of the base station according to the second embodiment of the present invention is described by reference to a block diagram shown in FIG. 9.

A receiver 401 receives a connection setup complete message that represents completion of a connection setup and that is transmitted from the user equipment, and outputs the thus-received message to a connection setup complete message acquisition section 409. Further, the receiver 401 receives the HO request and the key information and also outputs the thus received HO request to the HO request processing unit 202 and the key information to the key information storage section 203, in the same way as does the configuration described in connection with the first embodiment shown in FIG. 2.

The connection setup complete message acquisition section 409 extracts user equipment information from the connection setup complete message input by the receiver 401 and outputs the thus-extracted user equipment information to a user equipment information determination section 404.

The user equipment information determination section 404 determines a mode of handover in accordance with the user equipment information input by the connection setup complete message acquisition section 409 and outputs a determination result to a security mode command preparation section 410. Further, the user equipment information determination section 404 determines a mode of handover in accordance with the user equipment information input by the HO request processing unit 202 and outputs a determination result to the key generator 205 and the HO command preparation section 207, respectively, in the same way as does the configuration described in connection with the first embodiment shown in FIG. 2.

The security mode command preparation section 410 prepares a security mode command for specifying a security algorithm, which is to be used for encrypting and signing communication between the user equipment and the base station or communication between relay nodes, in accordance with the determination result input by the user equipment information determination section 404 and outputs the thus-prepared security mode command to a transmitter 408.

The transmitter 408 transmits the security mode command input by the security mode command preparation section 410 and the HO command input by the HO command preparation section 207 from an antenna.

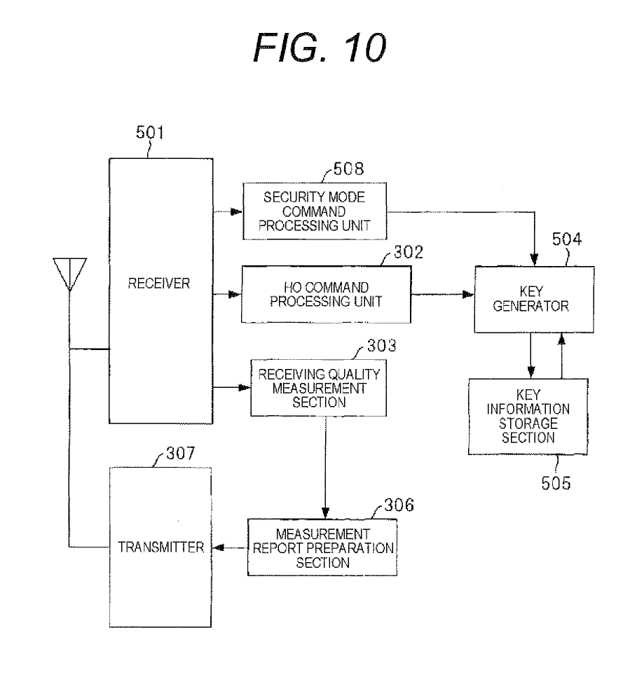

A configuration of the user equipment according to the second embodiment of the present invention is described by reference to the block diagram shown in FIG. 10.

A receiver 501 receives a security mode command, an HO command, and a pilot signal included in a transmission signal, all, of which are sent from another base station. Further, the receiver 501 outputs the thus-received security mode command to a security mode command processing unit 508, the HO command to the HO command processing unit 302, and the pilot signal to the receiving quality measurement section 303.

The security mode command processing unit 508 commands a key generator 504 to generate a key in accordance with a security mode command input by the receiver 501.

The key generator 504 acquires required information from a key information storage section 505 in accordance with commands input by the security mode command processing unit 508 and the HO command processing unit 302; generates an encryption key; and outputs the thus-generated key to the key information storage section 505.

The key information storage section 505 stores the key information input by the key generator 504. The key information storage section 505 also outputs necessary key information to the key generator 504.

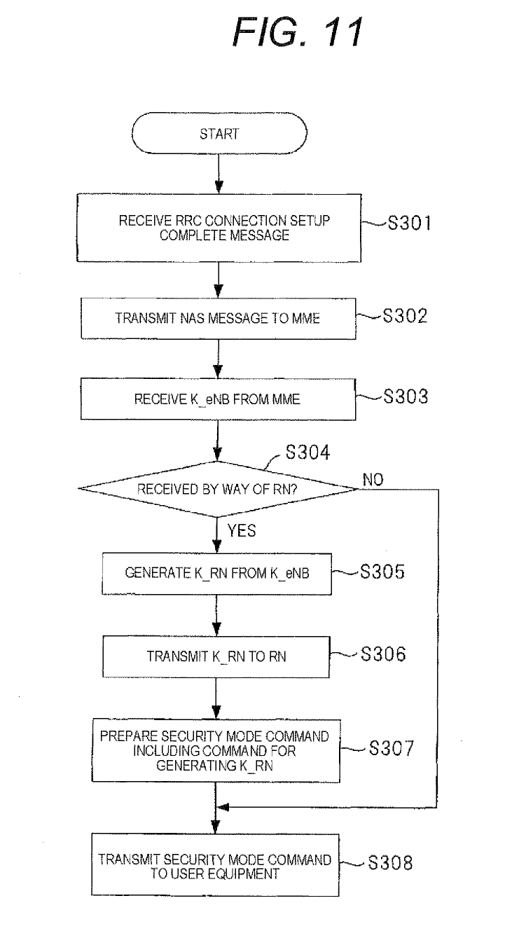

Operation of the base station according to the second embodiment of the present invention is now described by reference to the flowchart shown in FIG. 11.

The base station 101 receives the RRC connection setup complete message transmitted from the user equipment 102 by means of the receiver 401 (S301).

The base station 101 transmits to the MME 105, which is a high-level management node, a NAS message that is a message used between the user equipment 102 and the MME 105, by means of the transmitter 408 (S302); receives from the MME 105 the key K_eNB used between the user equipment 102 and the base station 101 by means of the receiver 401; and stores the thus-received key into the key information storage section 203 (S303).

The base station 101 then determines whether or not the thus-received RRC connection setup complete message has been received by way of the relay node (RN) 103, by means of the connection setup complete message acquisition section 409 and the user equipment information determination section 404 (S304). When the RRC connection setup complete message has been received by way of the relay node 103, the key generator 205 multiplies the key K_eNB received from the MME 105 by the physical cell ID of the relay node 103, thereby generating the key K_RN used between the user equipment 102 and the relay node 103 (S305). The base station 101 transmits the thus-prepared key K_RN to the relay node 103 from the transmitter 408 (S306).

The base station 101 then prepares a security mode command including a command for generating the key K_RN by means of the security mode command preparation section 410 (S307) and transmits the thus-prepared security mode command from the transmitter 408 to the user equipment 102 by way of the relay node 103 (S308).

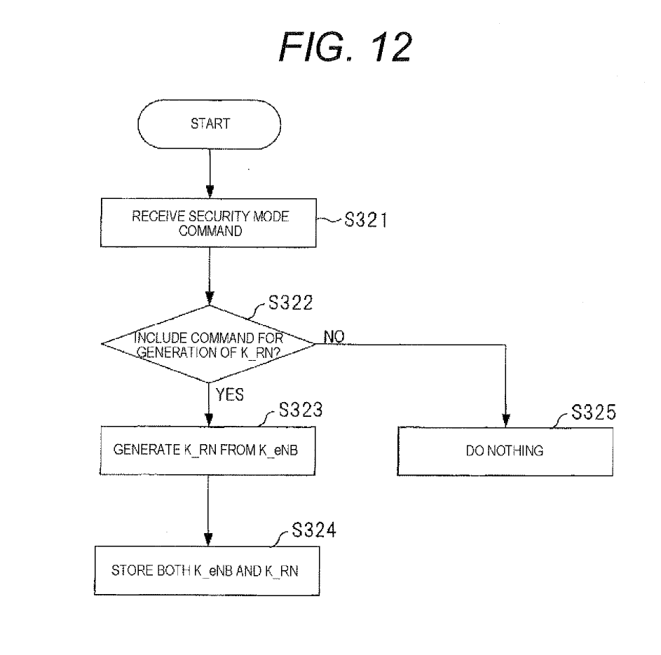

Operation of the user equipment according to the second embodiment of the present invention is now described by reference to the flowchart shown in FIG. 12.

The user equipment 102 receives the security mode command from the base station 101 in the currently communicable serving cell, by means of the receiver 501 and the security mode command processing unit 508 (S321).

The security mode command processing unit 508 then determines whether or not the security mode command includes a command for generating the key K_RN (S322). When the security mode command includes a command for generating the key K_RN, the key generator 504 multiplies the key K_eNB being currently used by the physical cell ID of the relay node 103, thereby generating the key K_RN from the key K_eNB (S323) and holds the key K_RN along with the key K_eNB that is the source of generation of the key (S324). On the contrary, when the command for generating the key K_RN is not included in the security mode command, the process ends without performing any operation (S325).

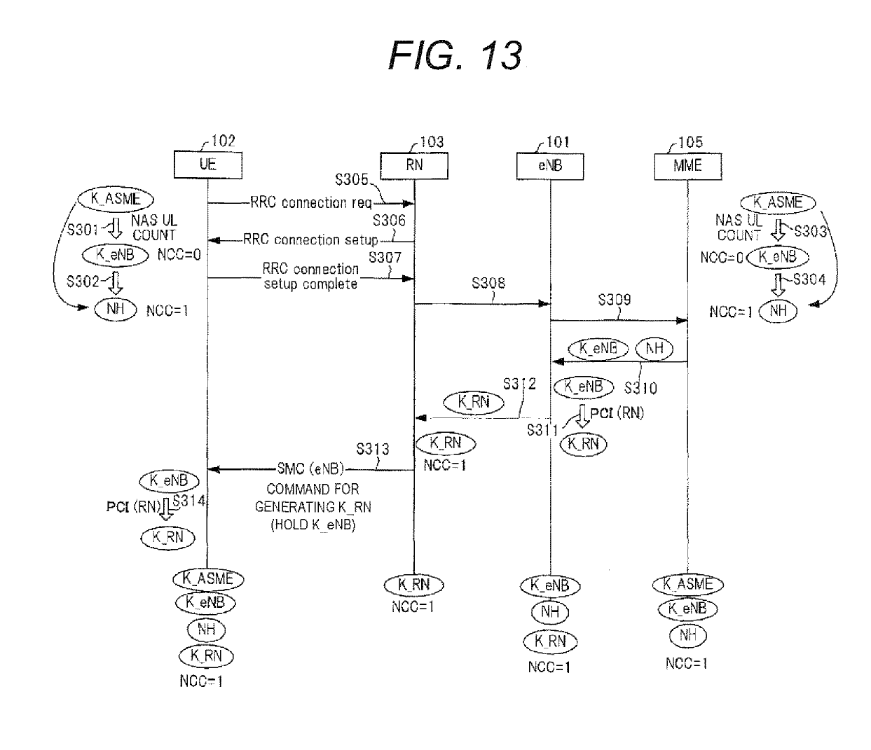

Example signaling performed between the base station and the user equipment in the second embodiment of the present invention is described by reference to a signaling chart shown in FIG. 13.

In FIG. 13, the user equipment (UE) 102 and the MME 105 hold the common key K_ASME and respectively multiply K_ASME by a NAS uplink count (NAS UL COUNT), thereby preparing keys K_eNB (S301 and S303). Further, key information NH (Next Hop) is prepared from the key K_ASME and the key K_eNB (S302, S304). The key generation operation is performed when the cellular mobile communication system authenticates a user equipment and when the key K_ASME is updated, such as at power-on of the user equipment 102.

When the user equipment 102 establishes an RRC connection with the relay node (RN) 103, the RRC connection request (RRC connection req), the RRC connection setup, and the RRC connection setup complete are exchanged between the user equipment 102 and the relay node 103 (S305, S306, and S307). Upon receipt of the RRC connection setup complete message from the user equipment 102, the relay node 103 transfers the message to the base station 101 (S308). Upon receipt of the RRC connection setup complete message from the relay node 103, the base station 101 transfers the NAS message to the MME 105 (S309). The MME 105 at this time notifies the base station 101 of the key K_eNB and the key information NH (NCC=1) (S310).

When the RRC connection setup complete message is received by way of the relay node 103, the base station 101 multiplies the key K_eNB notified by the MME 105 by the physical cell ID of the relay node 103, thereby generating the key K_RN (S311), and notifies the relay node 103 of the key K_RN (S312).

When generating the key K_RN, the base station 101 prepares the security mode command (SMC) including a command for holding the key K_eNB and transmits the thus-prepared command to the user equipment 102 by way of the relay node 103 (S313).

The user equipment 102 receives the security mode command. When the security mode command includes a command for generating the key K_RN, the user equipment multiplies the key K_eNB by the physical cell ID of the relay node 103, thereby generating the key K_RN from the key K_eNB (S314), and holds both the key K_eNB and the key K_RN.

Subsequently, the key K_RN is used for encrypting RCC signaling performed between the user equipment 102 and the relay node 103, and the key K_eNB is used for encrypting data signaling performed between the user equipment 102 and the base station 101.

Thereby, during communication performed after establishment of the connection, secure communication can be performed by use of the common key K_eNB between the user equipment and the base station and by use of the common key K_RN between the user equipment and the relay node.

As mentioned above, in the second embodiment, the data encryption key that is frequently exchanged is embodied as a key used between the user equipment and the base station, whereby the frequency of exchange of the key between the base station and the relay node can be reduced. Moreover, the RRC encryption key is embodied as a key used between the user equipment and the relay node, whereby a delay in RRC processing can be shortened.

The present invention is also scheduled to be subjected to various alterations and applications conceived by the persons skilled in the art according to the descriptions of the present patent specification and the well known techniques, without departing the spirit and scope of the present invention, and the alterations and applications shall also fall within a scope where protection of the present invention is sought. Further, the constituent elements described in connection with the embodiments can also be arbitrarily combined together without departing the purport of the present invention.

Although the present embodiments have provided explanations by means of taking, as examples, a case where the present invention is configured by means of hardware, the present invention can also be implemented by software.

The respective functional blocks used for describing the respective embodiments are typically implemented by LSIs that are integrated circuits. The function blocks can also be individually realized as single chips or as a single chip including some or all of the function blocks. Although the function blocks are embodied as LSIs, they are sometimes called an IC, a system LSI, a super LSI, and an ultra-LSI according to a degree of integration.

The technique for integrating the function blocks into circuitry is not limited to LSI technology, and the function blocks can also be implemented by means of a custom-designed circuit or a general-purpose processor. Further, an FPGA (Field Programmable Gate Array) capable of being programmed after manufacture of an LSI and a reconfigurable processor whose connections or settings of circuit cells in an LSI can be reconfigured can also be utilized.

Further, if a technique for integrating circuits replaceable with the LSI technology by virtue of advancement of the semiconductor technology or another technique derived from advancement of the semiconductor technology has emerged, the function blocks can naturally be integrated by use of the technique. Adaptation of biotechnology is feasible.

The present patent application is based on Japanese Patent Application (No. 2009-083224) filed on Mar. 31, 2009, the entire subject matter of which is incorporated herein by reference.

### INDUSTRIAL APPLICABILITY

The present invention yields an advantage of the ability to diminish influence on a key used between a user equipment and a base station, which will be imposed by unsecured updating of a key between the base station and a relay node when a relay node is introduced into a cellular mobile communication system, as well as yielding an advantage of the ability to enable correct generation and use of a common key between a user equipment and a base station and between the user equipment and a relay node when a relay node is introduced into a cellular mobile communication system. Thus, the invention is useful as a wireless communication apparatus, or the like, applicable to a wireless communication base station apparatus, a wireless communication user equipment, and the like.

### REFERENCE SIGNS LIST

101, 101A, 101B: BASE STATION
102: USER EQUIPMENT
103, 103A, 103B, 103C: RELAY NODE
105: MME
201, 401: RECEIVER
202: HO REQUEST PROCESSING UNIT
203: KEY INFORMATION STORAGE SECTION
204, 404: USER EQUIPMENT INFORMATION DETERMINATION SECTION
205: KEY GENERATOR
207: HO COMMAND PREPARATION SECTION
208, 408: TRANSMITTER
301, 501: RECEIVER
302: HO COMMAND PROCESSING UNIT
303: RECEIVING QUALITY MEASUREMENT SECTION
304, 504: KEY GENERATOR
305, 505: KEY INFORMATION STORAGE SECTION
306: MEASUREMENT REPORT PREPARATION SECTION
307: TRANSMITTER
409: CONNECTION SETUP COMPLETE MESSAGE ACQUISITION SECTION
410: SECURITY MODE COMMAND PREPARATION SECTION
508: SECURITY MODE COMMAND PROCESSING UNIT

1-14. (canceled)

15. A wireless communication apparatus, comprising:
a receiver that receives a handover request representing a request for handover, which is sent from another apparatus, and receives key information about an encryption key;
a handover request processing unit that processes the handover request received by the receiver;
a key information storage section that stores the key information received by the receiver;
a user equipment information determination section that determines a mode of handover in accordance with user equipment information extracted by the handover request processing unit;
a key generator that generates a key from the key information stored in the key information storage section in accordance with a determination result of the user equipment information determination section;
a handover command preparation section that prepares a handover command for commanding performance of handover in accordance with the determination result of the user equipment information determination section; and
a transmitter that transmits the handover command prepared by the handover command preparation section.

16. The wireless communication apparatus according to claim 15, wherein
when a user equipment that is in communication with the apparatus which has transmitted the handover request performs handover from a base station to a relay node subordinate to the base station, the user equipment information determination section commands the handover command preparation section to prepare a handover command including a command for holding a key that is a source of generation of the key.

17. The wireless communication apparatus according to claim 15, wherein
either when a user equipment that is in communication with the apparatus which has transmitted the handover request performs handover from a relay node to a high-level base station to which the relay node is subordinate or when the user equipment performs handover from a relay node to another base station to which the relay node is not subordinate, the user equipment information determination section commands the handover command preparation section to prepare a handover command including a command for updating a key used between the high-level base station for the relay node and the user equipment.

18. The wireless communication apparatus according to claim 15, wherein
either when the user equipment that is in communication with the apparatus which has transmitted the handover request performs handover from one relay node to another relay node that are subordinate to the same base station, when the user equipment performs handover from one base station to a relay node subordinate to a different base station, or when the user equipment performs handover from a relay node subordinate to one base station to a relay node subordinate to another base station, the user equipment information determination section commands the handover command preparation section to prepare a handover command including a physical cell ID of the corresponding base station.

19. The wireless communication apparatus according to claim 15, further comprising:
a connection setup complete message acquisition section that acquires a connection setup complete message which indicates completion of setup of a connection between a user equipment and a base station or between the user equipment and a relay node; and
a security mode command preparation section that prepares a security mode command that is a command pertaining to communication encryption, wherein
the user equipment information determination section determines whether the connection setup complete message extracted by the connection setup complete message acquisition section has been sent by way of the relay node.

20. The wireless communication apparatus according to claim 19, wherein
when the connection setup complete message has been sent by way of the relay node in accordance with a determination result of the user equipment information determination section, the security mode command preparation section prepares a security mode command including a command for preparation of a key used between the relay node and the user equipment as well as preparation of a key used between the base station and the user equipment.

21. A wireless communication apparatus, comprising:
a receiver that receives a handover command for commanding performance of handover sent from another apparatus and receives a pilot signal included in a transmission signal;
a handover command processing unit that processes the handover command which has been received by the receiver and which is commensurate with a mode of handover;
a key generator that generates a key in accordance with the handover command;
a key information storage section that stores the key generated by the key generator;
a receiving quality measurement section that measures receiving quality of the pilot signal received by the receiver;
a measurement report preparation section that prepares a measurement report from a measurement result of the receiving quality measurement section; and
a transmitter that transmits the measurement report.

22. The wireless communication apparatus according to claim 21, wherein
when the handover command includes a command for holding a key that is a source of generation of the key, the handover command processing unit commands the key generator to store both a new key and the key that is the source of generation of the key after generation of the new key.

23. The wireless communication apparatus according to claim 21, wherein
when the handover command includes a command for updating a key used between a base station and a user equipment, the handover command processing unit commands the key generator to fetch the key used between the base station and the user equipment from the key information storage section, to generate a new key, and to input the thus-generated new key into the key information storage section.

24. The wireless communication apparatus according to claim 21, wherein
when the handover command includes a physical cell ID of the base station, the handover command processing unit commands the key generator to fetch the key used between the base station and the user equipment from the key information storage section, generate a new key, to generate another key to be used between the relay node and the user equipment from the thus-generated new key, and input the newly generated two keys into the key information storage section.

25. The wireless communication apparatus according to claim 21, further comprising:
a security mode command processing unit that processes a security mode command that has been received by the receiver and that is a command pertaining to communication encryption, wherein,
when the security mode command includes a command for generating a key to be used between the relay node and the user equipment as well as including a key to be used between the base station and the user equipment, the security mode command processing unit commands the key generator to fetch the key used between the base station and the user equipment from the key information storage section and newly generate a key to be used between the relay node and the user equipment.

26. A base station apparatus comprising the wireless communication apparatus as defined in claim 15.

27. A user equipment comprising the wireless communication apparatus as defined in claim 21.

28. A wireless communication system comprising:
a base station; and
a user equipment, wherein
the base station includes:
a receiver that receives a handover request representing a request for handover, which is sent from another apparatus, and receives key information about an encryption key;
a handover request processing unit that processes the handover request received by the receiver;
a key information storage section that stores the key information received by the receiver;
a user equipment information determination section that determines a mode of handover in accordance with user equipment information extracted by the handover request processing unit;
a key generator that generates a key from the key information stored in the key information storage section in accordance with a determination result of the user equipment information determination section;
a handover command preparation section that prepares a handover command for commanding performance of handover in accordance with the determination result of the user equipment information determination section; and
a transmitter that transmits the handover command prepared by the handover command preparation section, and
the user equipment includes:
a receiver that receives the handover command for commanding performance of handover transmitted from the base station and receives a pilot signal included in a transmission signal;
a handover command processing unit that processes the handover command which has been received by the receiver and which is commensurate with a mode of handover;
a key generator that generates a key in accordance with the handover command;
a key information storage section that stores the key generated by the key generator;
a receiving quality measurement section that measures receiving quality of the pilot signal received by the receiver;
a measurement report preparation section that prepares a measurement report from a measurement result of the receiving quality measurement section; and
a transmitter that transmits the measurement report.
